(19) United States
(12) Patent Application Publication
(10) Pub. No.: US 2010/0224307 A1
(43) Pub. Date: Sep. 9, 2010

(54) Fiberglass Splicing Method

(75) Inventors: Amir Khan, Wayne, NJ (US); Burhan Uludag, Budd Lake, NJ (US)

Correspondence Address: GAF Materials Corporation;Attn: William J. Davis, Esq., Legal Department, 1361 Alps Road, Building No. 8-2, Wayne, NJ, 07470, US

(73) Assignee: Building Materials Investment Corporation, Wilmington, DE (US)

(21) Appl. No.: 12/729,030

(22) Filed: Mar. 22, 2010

Related U.S. Application Data
(63) Continuation-in-part of application No. 11/242,478, filed on Oct. 3, 2005, now abandoned.

(51) Int. Cl. B29C 65/14; B29C 65/52

(52) U.S. Cl. 156/71

(57) ABSTRACT

A method of increasing the shear and tensile strength of spliced reinforcement panels used in roofing and waterproofing applications. The method is accomplished by facing and aligning at least two reinforcement panels in an end-to-end fashion on a roof deck in such a way that a seam is formed between the at least two reinforcement panels. A UV curable adhesive is then applied across the seam in a saw-tooth pattern and cured with a UV light source. The resultant spliced reinforcement panels will have a maximum load of approximately 34.4 to 48.8 lbf and a tensile strength of approximately 2.3 to 2.8%.

### CROSS-REFERENCE TO RELATED APPLICATION

The present invention is a continuation-in-part of co-pending U.S. patent application Ser. No. 11/242,478 filed on Oct. 3, 2005 entitled “FIBERGLASS SPLICING METHOD,” herein incorporated by reference in its entirety.

### FIELD OF THE INVENTION

The present invention relates to a splicing method. More particularly, the invention relates to a method for splicing fiberglass, polyester or combinations thereof and which eliminates waste, reduces splicing time and improves the mechanical properties of the resultant mat.

### BACKGROUND OF THE INVENTION

Currently, during installation of roofing and waterproofing reinforcement panels at a job site, a hot melt tape is used to splice the reinforcement panels together. This method, however, is ineffective and wasteful since much of the coated material must be discarded. Other on-site methods of splicing reinforcement panels together require the overlap of one end of a first reinforcement panel on the end of a second reinforcement panel that the first reinforcement panel is being spliced with. This method is also wasteful and does not permit utilization of the entire length of the reinforcement panels since part of one reinforcement panel receives the overlapping portion of the other panel.

### SUMMARY OF THE INVENTION

The invention provides a splicing method comprising the steps of: aligning facing ends of two reinforcement panels; securing said reinforcement panels to reduce movement or shifting; applying adhesive on said facing ends of said two reinforcement panels; butting together said facing ends of said two reinforcement panels; and applying an ultraviolet source to the adhesive.

The invention further provides a method for forming an adhered reinforcement panel comprising the steps of splicing method comprising the steps of: aligning facing ends of two reinforcement panels; securing said reinforcement panels to reduce movement or shifting; applying adhesive on said facing ends of said two reinforcement panels; butting together said facing ends of said two reinforcement panels; and applying an ultraviolet source to the adhesive.

The invention further provides for a method that increases the shear and tensile strength of spliced reinforcement panels used in roofing and waterproofing applications. The method is accomplished by facing and aligning at least two reinforcement panels in an end-to-end fashion on an installation surface in such a way that a seam is formed between the at least two reinforcement panels, applying a UV curable adhesive across the seam in a saw-tooth pattern and curing the UV curable adhesive with a UV light source. The reinforcement panels may be secured to the installation surface by a restraining apparatus or clamps prior to applying the adhesive so as to reduce movement or shifting during application.

The resultant spliced reinforcement panels will have a maximum load of approximately 34.4 to 48.8 lbf and a tensile strength of approximately 2.3 to 2.8%. These panels exceed the maximum load and tensile strength of the prior art methods of splicing roofing panels.

The reinforcement panels may be fiberglass, polyester and combinations thereof and may be strengthened by incorporating one or more of woven glass fibers, non-woven glass fibers, polyester mats, polyester scrims, nylon, and polyethylene sheeting into the reinforcement panels.

The adhesive used to splice the panels may be a UV curable adhesive such as an acrylic based ester adhesive. The ultraviolet light source used to cure the adhesive may be a high intensity ultraviolet light that may be applied to the UV curable adhesive for 5-20 seconds, preferably, 5 seconds.

The method of the present invention provides for precision bonding is faster and simpler thus rendering the splicing more efficient. Additionally, the method provides improved tensile strength and eliminates waste.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

FIG. 1 shows a first embodiment of the present invention;

FIG. 2a shows the adhesive applied as a straight line;

FIG. 2b shows the adhesive applied as dots;

FIG. 2c shows the adhesive applied in a saw tooth pattern.

### DETAILED DESCRIPTION OF THE DISCLOSED EMBODIMENT

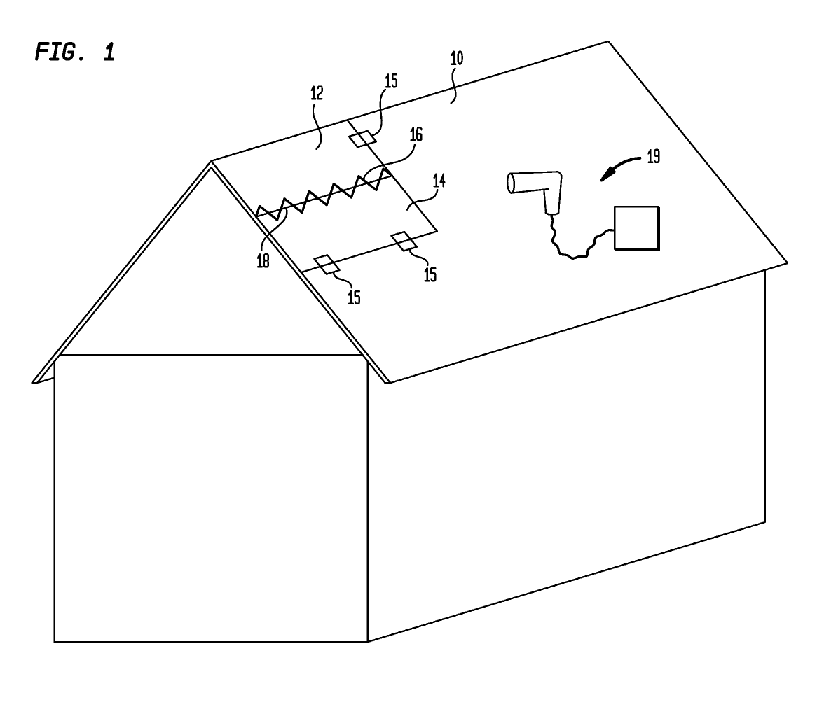

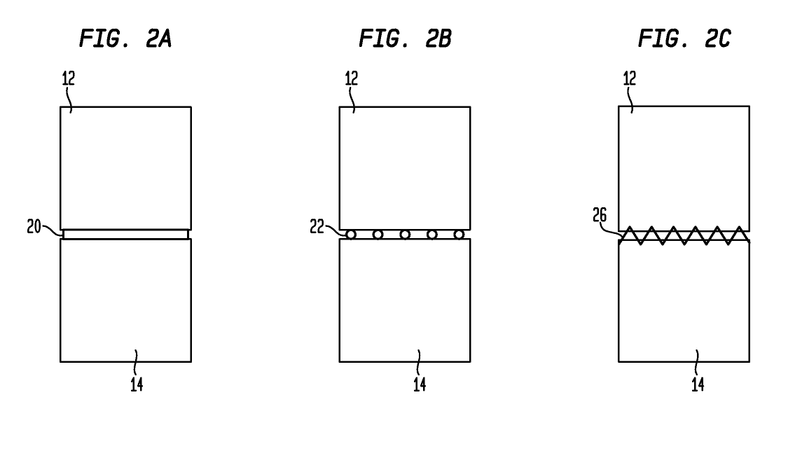

As shown in FIG. 1, the method according to the present invention is preformed at a job site and not in a factory setting. The method first requires the alignment of two facing reinforcement panels 12, 14 on an installation surface 10, for example, a roof deck 10. In a first embodiment, the facing panels 12, 14 are not overlapped, but are brought together in an end-to-end fashion and diametrically opposite one another so as to form a seam 18 between the facing panels 12, 14. An adhesive 16 is then applied across the seam 18. As shown in FIGS. 2a-c, the adhesive 18 may be applied as a straight line 20, as dots 22 or in a saw tooth pattern 26. The adhesive 18 is then cured by application of an ultraviolet light source 19 to the adhesive. In order to prevent or diminish movement of the panels 12, 14 during curing, the panels 12, 14 may be secured to the installation surface by a restraining apparatus or clamp 15.

In a second embodiment (not shown in the figures), the facing panels are also not overlapped, but are brought together in an end-to-end fashion and diametrically opposite one another. An adhesive is then applied on each of the facing ends of the panels. The ends with adhesive thereon are then brought together and cured by application of an ultraviolet light source to the adhesive.

Reinforcement panels 12, 14 are typically roofing or waterproofing membranes that have been strengthened by the addition or incorporation of one or more reinforcing materials, including woven or nonwoven glass fibers, polyester mats or scrims, nylon, or polyethylene sheeting. The reinforcement panels 12, 14 in accordance with the present invention are advantageously fiberglass or polyester, although the invention is not intended to be limited in this respect. The panels 12, 14 which are adhered to each other and cured in accordance with the method of the invention may be of the same composition, different or combinations thereof. For example, the reinforcement panels 12, 14 being spliced together may both be polyester, or they may both be fiberglass. Additionally, one panel may be fiberglass and spliced to a polyester panel.

The adhesive 16 used in accordance with the present invention may be any commercially available UV curable adhesive. Preferable UV curable adhesives include Loctite® 3494, 3491, 3492, 3525, 3526, but not are not limited thereto. The adhesive 16 can be acrylic based esters with UV curing technology and may also contain silicones and derivatives thereof. The adhesive 16 may be applied by hand or may be dispensed through a series of nozzles or syringes. During application, the adhesive may be placed on to the ends of the reinforcement panels and allowed to cure under UV light when the reinforcement panels are brought together in butting configuration. Or the reinforcement panels may be brought together in butting configuration and the adhesive placed across the splice and then cured. The dispensation of adhesive 16 is typically metered in accordance with predetermined and pre-set parameters.

The UV light source 19 may be any commercially available ultraviolet source which can be quickly and easily applied to the adhesive. The UV light source may be low, medium or high intensity. In a preferred embodiment, the UV light source has a high intensity and is applied to the adhesive for 5-20 seconds. Depending on various factors such as the type of adhesive use, the duration of application of the UV light to the adhesive will vary. The UV light source may be low, medium or high intensity, with a high intensity source being preferable.

As shown in Examples 1-5 below, the on-site installation method in accordance with the present invention increases the shear and tensile strength both in the machine and cross machine directions over the traditional hot melt approach.

### Example 1

Two waterproofing roof membranes are laid on a roof deck at a job site. The membranes are brought together in an end-to-end fashion so as to form a seam between the two membranes. The membranes are then secured to the roof deck with a clamping device. A thin line of a UV activated adhesive is then applied directly across the seam in a straight line. The adhesive is then cured using a high-intensity UV light source. The UV light is applied for approximately 5-20 seconds.

### Example 2

Two waterproofing roof membranes are laid on an installation surface. The membranes are then brought together in an end-to-end fashion so as to form a seam between the two membranes. The membranes are then secured to the installation surface with a clamp device. A thick line of a UV activated adhesive is then applied directly across the seam in a straight line. The adhesive is then cured using a high-intensity UV light source. The UV light is applied for approximately 5-20 seconds.

### Example 3

Two waterproofing roof membranes are laid on an installation surface. The membranes are then brought together in an end-to-end fashion so as to form a seam between the two membranes. The membranes are then secured to the installation surface with a clamp device. A UV activated adhesive is applied as dots across the seam. The adhesive is then cured using a high-intensity UV light source. The UV light is applied for approximately 5-20 seconds.

### Example 4

Two waterproofing roof membranes are laid on an installation surface. The membranes are then brought together in an end-to-end fashion so as to form a seam between the two membranes. The membranes are then secured to the installation surface with a clamp device. A thin line of a UV activated adhesive is then applied across the seam in a saw-tooth pattern. The adhesive is then cured using a high-intensity UV light source. The UV light is applied for approximately 5-20 seconds.

### Example 5

Two waterproofing roof membranes are laid on an installation surface. The membranes are then brought together in an end-to-end fashion so as to form a seam between the two membranes. The membranes are then secured to the installation surface with a clamp device. A thick line of a UV activated adhesive is then applied across the seam in a saw-tooth pattern. The adhesive is then cured using a high-intensity UV light source. The UV light is applied for approximately 5-20 seconds.

Comparative results for Examples 1-5 are shown in the following chart:

| | | Max | Tensile | |
|---|---|---|---|---|
| | | Load | Strength | |
| | Sample Type and ID | (lbf) | (%) | Comments |
| Prior | Current Stocton Heat | 33 | 1.5 | Hot Pressed. The |
| Art | Activated Tape | | | polyester backing |
| Example | | | | does not saturate |
| | | | | with asphalt. |
| Example 1 | Loctite ® Adhesive | 54 | 3.4 | Thin strip of |
| | | | | adhesive laid |
| | | | | across splice. |
| Example 2 | Loctite ® Adhesive | 66 | 3.7 | Thick strip of |
| | | | | adhesive laid |
| | | | | across splice. |
| Example 3 | Loctite ® Adhesive | 40.4 | 2.5 | Adhesive is spaced |
| | | | | with small |
| | | | | amounts of |
| | | | | adhesive applied as |
| | | | | dots. |
| Example 4 | Loctite ® Adhesive | 34.4 | 2.3 | Thin strip of |
| | | | | adhesive laid |
| | | | | across seam in a |
| | | | | saw tooth pattern. |
| Example 5 | Loctite ® Adhesive | 48.4 | 2.8 | Thick strip of |
| | | | | adhesive laid |
| | | | | across seam in a |
| | | | | saw tooth pattern. |

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method of increasing the shear and tensile strength of spliced reinforcement panels used in roofing and waterproofing applications comprising the steps of:
a. facing and aligning at least two reinforcement panels in an end-to-end fashion on an installation surface in such a way that a seam is formed between the at least two reinforcement panels;
b. applying a UV curable adhesive across the seam in a saw-tooth pattern; and
c. curing the UV curable adhesive with a UV light source.

2. The method of claim 1 wherein the spliced reinforcement panels have a maximum load of approximately 34.4 to 48.8 lbf and a tensile strength of approximately 2.3 to 2.8%.

3. The method of claim 1 wherein the reinforcement panels are one of fiberglass, polyester and combinations thereof.

4. The method of claim 3 wherein the reinforcement panels are strengthened by incorporating one or more of woven glass fibers, non-woven glass fibers, polyester mats, polyester scrims, nylon, and polyethylene sheeting into the reinforcement panels.

5. The method of claim 1 further comprising the step of:
securing the reinforcement panels to the installation surface so as to reduce movement or shifting during the applying step.

6. The method of claim 5 wherein the securing step is performed by a restraining apparatus or clamps.

7. The method of claim 1 wherein the UV curable adhesive is an acrylic based ester adhesive.

8. The method of claim 1 wherein the ultraviolet light source is a high intensity ultraviolet light.

9. The method of claim 1 wherein said ultraviolet light source is applied to the UV curable adhesive for 5-20 seconds.

10. The method of claim 1 wherein said ultraviolet light source is applied to the UV curable adhesive for 5 seconds.
